(19) United States
(12) Patent Application Publication
(10) Pub. No.: US 2013/0124628 A1
(43) Pub. Date: May 16, 2013

(54) METHOD AND APPARATUS FOR PROVIDING SOCIAL NETWORK BASED ADVERTISING WITH USER CONTROL AND PRIVACY

(71) Applicant: SRILAL WEERASINGHE, Austin, TX (US)

(72) Inventor: SRILAL WEERASINGHE, Austin, TX (US)

(21) Appl. No.: 13/297,015

(22) Filed: Nov. 15, 2011

(51) Int. Cl. G06F 15/16

(52) U.S. Cl. 709/204

(57) ABSTRACT

Methods for providing targeted content are disclosed. For example, the method registers a user profile with a social network and provides a user identifier associated with the user profile to a user device. The method then receives a request from a third party with the user identifier. The method determines whether the third party is authorized to receive the user profile and provides the user profile to the third party if the third party is authorized.

The present disclosure relates generally to communication networks and, more particularly, to methods and apparatus for providing a user-controlled platform for receiving targeted advertising with enhanced privacy.

### BACKGROUND

Upholding user privacy vs. divulging user data has been an ongoing struggle for social networks. On the one hand, a revenue model can be based on gathering user profiles for targeted advertising. On the other hand, the user base is wary of revealing personal data to third parties. Thus, there appears to be an uneasy tension between social networks and their user base.

### SUMMARY

In one embodiment, the present disclosure discloses a method for sharing user data. For example, the method registers a user profile with a social network and provides a user identifier associated with the user profile to a user device. The method then receives a request from a third party with the user identifier. The method determines whether the third party is authorized to receive the user profile and provides the user profile to the third party if the third party is authorized.

In another embodiment, the present disclosure discloses a method for providing targeted content. For example, the method receives a user identifier from a user device and forwards a request to a social network with the user identifier. The method then receives a user profile associated with the user identifier and provides targeted content to the user device based on the user profile.

### BRIEF DESCRIPTION OF THE DRAWINGS

The teachings of the present disclosure can be readily understood by considering the following detailed description in conjunction with the accompanying drawings, in which:

FIG. 1 illustrates an exemplary system according to embodiments of the present disclosure;

FIG. 2 illustrates a flowchart of a method for sharing user data, according to embodiments of the present disclosure;

FIG. 3 illustrates a flowchart of another method for providing targeted content, according to embodiments of the present disclosure;

FIG. 4 illustrates a flowchart of a method for receiving targeted content, according to embodiments of the present disclosure;

FIG. 5 illustrates an exemplary anonymous user profile template, according to embodiments of the present disclosure; and

FIG. 6 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses methods and computer-readable media for providing and receiving targeted content while allowing a user to maintain and control his or her own level of privacy. Although the present disclosure may describe embodiments in the context of particular networks, systems and environments, the present disclosure is not so limited. Namely, the present disclosure can be applied to any type of computer-based communication network that is capable of supporting communications between devices.

Broadly, a social network is a virtual place for people to congregate and keep contact with friends. A social network has been defined as a structure made up of individuals or nodes (e.g., representing a person or group of people) and edges, or connections to other nodes based upon various types of relationships (e.g., family, friend, neighbor, business associate, etc.). In the context of the present disclosure, a social network is a formalized online social structure wherein individuals are registered users of the social network and define their relationships to other registered users via various mechanisms through which an individual can associate his or her profile with the other registered users.

Social networks of this type may share data regarding user profiles and other activities to third parties to generate targeted advertisements (ads). Social networks may offer assistance to companies that wish to engage in targeted advertising based on user preferences, age, and other demographic details by sharing user profile data and other information. In addition, often unbeknownst to a user, numerous other web activities on the user's computer may be tracked and sent to the social network. For example, some portions of third party websites may track users surreptitiously during general web browsing and may provide activity information back (broadly “link back”) to a social network profile (e.g., when a “Like” button is selected by a user on a website). This may occur even if the user is not logged into a social network account or even if the link back to the social network is not touched (only the web page need to be opened). However, there may be public concern against such arrangements as it allows social network sites to monitor user activities during general web browsing. In addition, a lack of regard for user privacy has the potential to diminish a social network's user base as more users become aware that their data is being shared indiscriminately. The embodiments of the present disclosure obviate the need for such unwarranted tracking.

On the other hand, social networks provide a valuable service at little or no direct cost to the user base, while such social networks may need to derive revenue from existing business models based on advertising and data sharing in order to survive. However, it has been observed that placing ads on a social network user page does not garner much attention and is not very effective from a revenue standpoint. For instance, studies have revealed that social network advertisements have very little impact in influencing consumer purchasing decisions, whereas advertising during general web-browsing, when a user is actively engaged in search, is more effective.

Embodiments of the present disclosure provide a sustaining model for advertising and revenue generation for social networks with more user control and privacy. The present disclosure allows the user to have control over how much (anonymous) user profile data to release, and may do so in exchange for compensation (e.g., in the form of real or virtual currency).

In embodiments of the present disclosure, user control is enabled in several ways. For instance, a user may determine which portions of a social network profile may be shared and with whom. In one embodiment, the social network may support this feature by providing a form with check boxes for the user to select. In another embodiment, a separate anonymous user profile may be created to achieve the same end. For purposes of the following discussion, “anonymous user profile” shall refer to both arrangements. In any case, personally identifiable data (full name and birth date) is not shared. In one embodiment, as compensation for sharing the anonymous user profile data, the user may earn a fee (e.g., in the form of “real” money/currency, virtual currency/credits, free content or services from third parties or the social network, or other valuable consideration). In addition, the more information that the user is willing to share, the greater the user's earnings.

In one embodiment, a new feedback feature is added to browsers providing the ability to click on an advertisement and mark it as “not interested.” This information may be transmitted to a social network server and/or advertising server. The intent is that by honoring the user request, a more receptive audience will emerge for targeted content/advertising. An example would be the case of an irrelevant advertisement. For example, a search engine/social network may have tracked a previous purchase activity and assumes that the user is still interested in receiving similar advertisements, whereas the user is no longer interested in this topic after having fulfilled his/her purchase.

The present disclosure presents a sustaining long-term advertising and revenue model facilitating targeted content/advertising. It does so by utilizing voluntary anonymous user profiles, but without empowering social networks to track user's general web activities (in contrast, to existing tools deployed by social networks that monitor users' general web activities even outside of the social network domain). As disclosed in the present disclosure, a social network is not made aware as to what web sites/pages a user is visiting or has visited. Instead, the social network receives a request (e.g., a “web-request” via the Internet) to supply the anonymous user profile data to a pre-approved site. In various embodiments, the request may originate from individual web sites/web servers, internet protocol television (IPTV) servers, site-aggregators or advertising agents/servers, and the like. In addition, embodiments of the present disclosure do not provide unfretted access to user data for third parties, such as websites, search engines, ad-agents, IPTV providers, and the like, to track online behavior. The only data to which these third parties have access is that which is explicitly designated and preapproved by the user in the voluntarily anonymous user profile registered via the social network. In one embodiment, a third party may pay/compensate the social network for the use of such data (e.g., according to a pre-arranged accounting scheme).

This approach provides many benefits. For example, search requests may produce more meaningful and relevant search results because they can be conducted with data specifically provided by the user via the anonymous user profile. In turn, the social network site may be remunerated for each web request, via the pre-arranged accounting scheme. Advertisers and web/content providers would benefit by knowing where to spend their marketing dollars more effectively.

At the same time, a third party would not have unfretted access to all of the user data on the social network site. Instead, in various embodiments third parties are permitted to receive only an anonymous user profile and activity data, sufficient for tailored content/advertising. Such data is released by the social network site only with the user's pre-approval according to the anonymous user profile settings.

Specifically, a user registers an anonymous user profile with the social network. In one embodiment, the anonymous user profile data is separate from a general user profile used within the social network setting itself. In various embodiments, the anonymous user profile includes data pertaining to the user's interests, demographic information such as, age, gender, income, geographic information, past, recent and current user activities within the social network, and other information as deemed appropriate to be distributed by the user. In addition, in various embodiments, the anonymous user profile also includes privacy settings which restrict the sharing of various portions of the user data in the anonymous user profile. For example, the anonymous user profile may indicate that the user is willing to share demographic information, but that access to the user's recent usage/activity data should be completely restricted/blocked and so on.

After creating the anonymous user profile, the user is provided with an anonymous user identifier by the social network. The social network stores the anonymous user profile along with the associated identifier in a database residing on a server. The user then provides the anonymous user identifier to third parties, such as web servers or advertising servers while web browsing, or IPTV servers which viewing IPTV programming. In turn, the third party forwards the anonymous user profile identifier to the social network requesting the associated anonymous user profile. If the third party is authorized by the social network, the social network provides the anonymous user profile to the third party. The third party may then use the anonymous user profile to provide targeted advertising or other related content to the user. Again, the user may include in the anonymous user profile as little or as much information as the user desires, thereby allowing the user to retain control of sensitive personal information.

In one embodiment, the present disclosure may be employed in a home based environment where there is more than one user sharing one or more user devices. Thus, a “one size fits all” approach to targeted ads may not be effective in such situations. For example, search engines may feed targeted ads to a family computer based on web surfing pattern of the previous user, which may be totally irrelevant to the next user in the family. The same issue applies in a home TV environment as the advertisements cater to all users sharing the facilities. Accordingly, one embodiment of the present disclosure introduces a “profile selection” icon (or button) on the console screen for a shared IPTV, PC, PDA or mobile device. Each user will be able to choose a relevant profile or a common profile as the case may be. The impetus for the usage of such feature would be the virtual currency/credit that the users may receive from the social network.

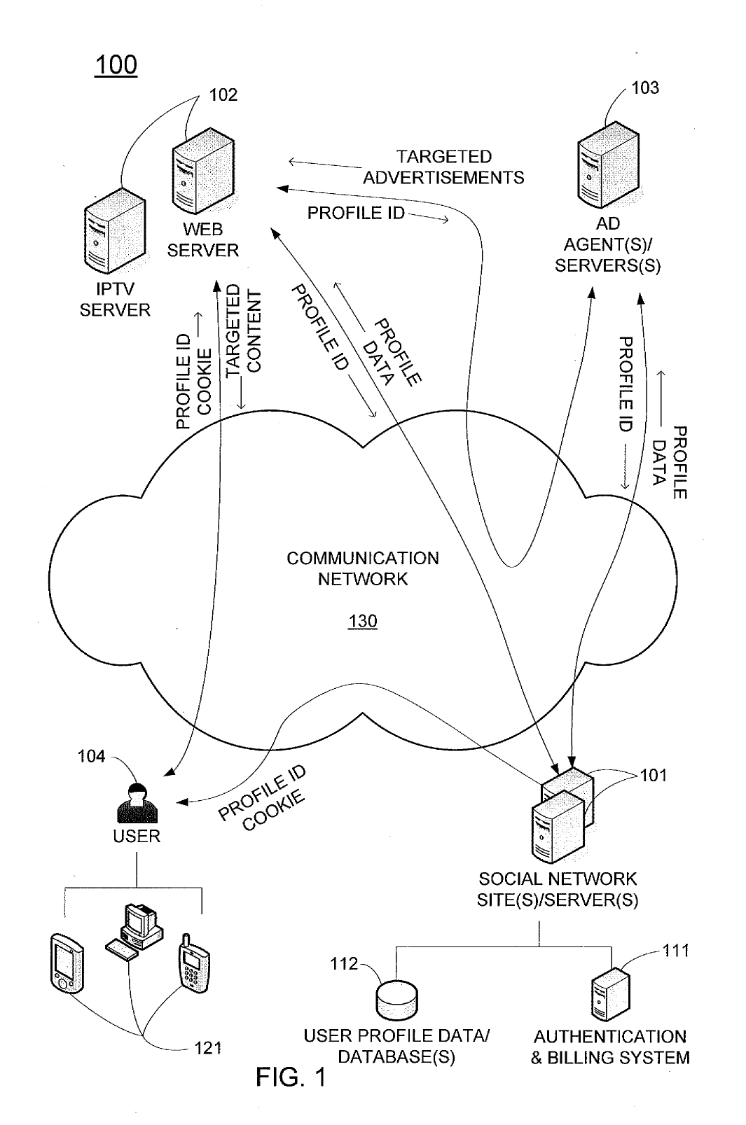

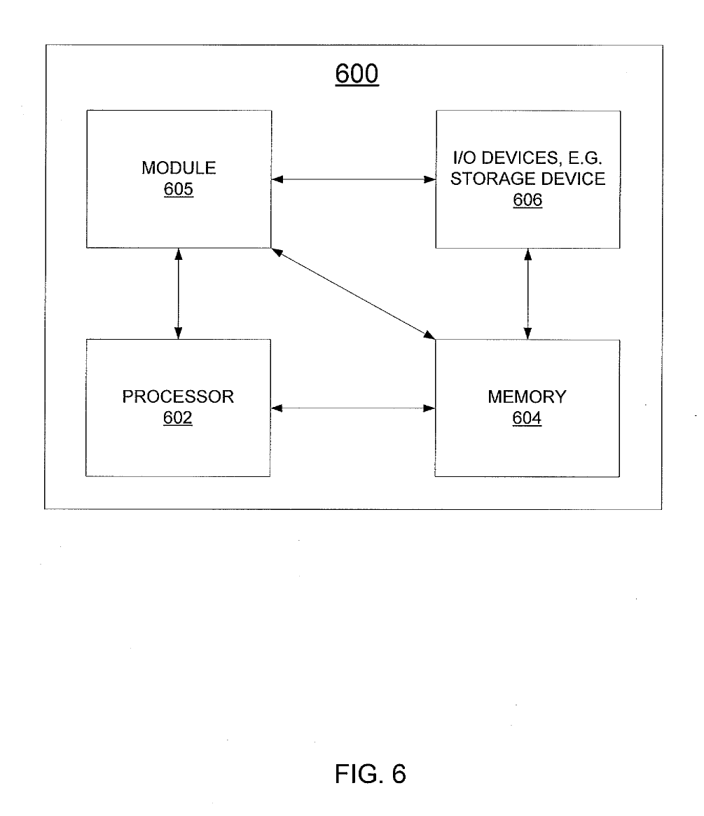

To better understand the present disclosure, FIG. 1 illustrates an example system 100, suitable for implementing embodiments of the present disclosure. The system 100 includes a communication network 130 interconnecting several devices associated with various entities. Several of the devices of system 100 may be referred to herein as servers. In general, a server is a hardware machine or computer that is well known in the art and may be configured to perform various functions as described herein. For example, a server, in accordance with various embodiments, may take the form of a general purpose computer (e.g., computer 600 as shown in FIG. 6) specifically configured to perform various functions as described herein. Communication network 130 may comprise any packet switched or circuit switched network, or any combination of such networks, e.g., Internet Protocol (IP) networks, wireless networks, Asynchronous Transfer Mode (ATM) networks, Frame Relay networks, and the like. For example, communication network 130 may comprise the internet, one or more wired, wireless or fiber optic networks, one or more access networks, metropolitan area networks (MANs), wide area networks (WANs), local area networks (LANs) and/or core networks to support communications between and among devices connected via the communication network 130.

Notably, the system 100 may also include a social network site 101, controlled by a social network provider. The social network site 101 may comprise at least one server, or a group of servers at a single location or distributed locations connected to the communication network 130. In one embodiment, the social network site 101, via the one or more severs, provides a social network website and associated database(s) 112 for storing user profile data and/or anonymous user profile data. In various embodiments, the social network site 101 also includes an authentication and billing system 111 which may reside on one or more distributed or co-located servers at one or more locations of the social network site.

The system 100 may also include at least one third-party device 102. In one embodiment, third party device 102 may comprise one or more servers hosting various services, such as: web server(s), IPTV content distribution systems (e.g., IPTV servers), search engine servers, and similar functions. Thus, third party device 102 may be a single server, controlled by a single entity, or may comprise separate devices (e.g., different servers, computers, etc.) hosted or maintained by the single entity, or a number of different entities.

In various embodiments, system 100 further includes at least one ad-agent 103. In one embodiment, ad-agent 103 comprises one or more advertising servers for generating and providing advertising content. For example, a web-site hosted on third-party device 102 may provide web-pages having advertising portions thereon, wherein the advertising is provided by a third party advertising server (e.g., ad-agent 103). Similarly, an IPTV provider may lease advertising space/time slots to external advertising conglomerates or to the channel content providers in the IPTV lineup, each of which may have their own advertising servers which may comprise ad-agent(s) 103.

The exemplary system 100 may also include one or more user devices 121 for interfacing user(s) 104 with the communication network 130, social network site 101, and/or third party device(s) 102. In various embodiments, the user devices 121 may comprise a personal computer, a smart phone, a cellular phone, a tablet, a Wi-Fi device, an Internet protocol television (IPTV) and/or set-top box, or any type of endpoint device configured for network-based communication.

Although the above described components and functions have been referred to with particular terms, it should be understood that the particular terms and embodiments depicted in FIG. 1 and described above are not the only embodiments of the present disclosure. Accordingly, it should be understood that other components and the terminology used to refer to such components may be used interchangeably with those depicted and described in connection with FIG. 1, depending upon the context and/or the particular network. For example, although the elements comprising the system 100 have been described as one or more discrete devices, the depicted arrangement is merely illustrative of one configuration that is suitable for implementing embodiments of the present disclosure. Thus, any other element or elements providing the same functionality described herein with respect to the user devices 121, communication network 130, third party device(s) 102, ad-agent 103 or social network site 101 would be equally suitable for use in accordance with embodiments of the present disclosure. For example, it should be realized that the system 100 may be expanded by including additional third party devices, ad-agents, social networks, etc., without altering the scope of the present disclosure. Accordingly, the foregoing is provided as an illustrative example only.

The system 100 of FIG. 1 is described to provide an illustrative environment in which targeted advertising can be provided to users based upon anonymous user profiles registered with a social network. Thus, the current disclosure discloses a method, computer readable media and apparatus for providing targeted advertising in an exemplary system illustrated in FIG. 1, and as described further below.

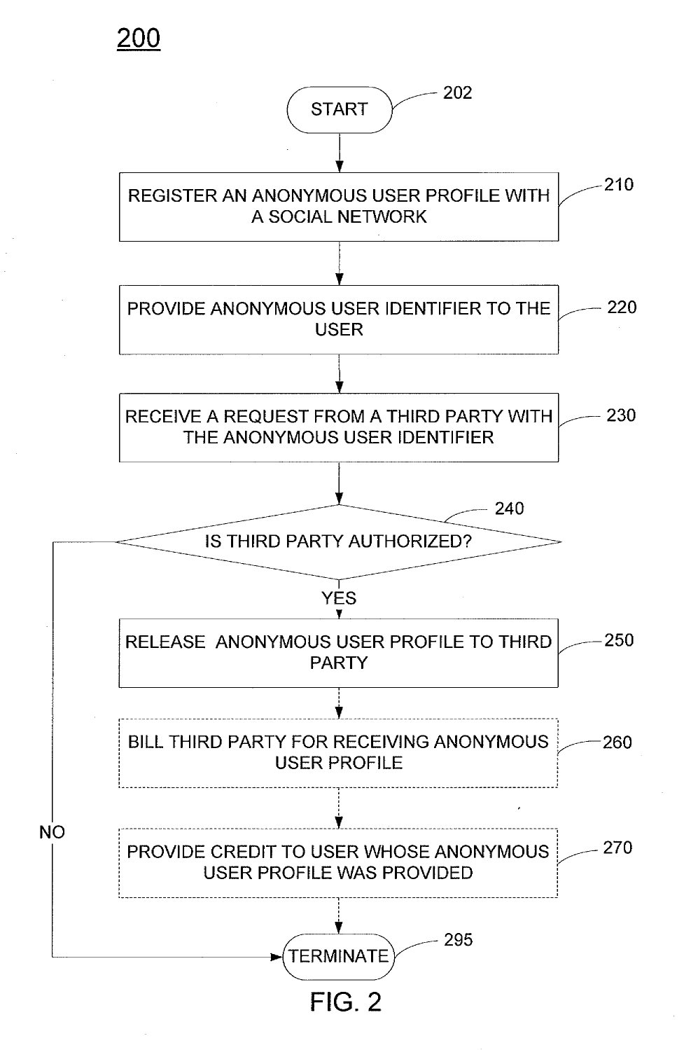

FIG. 2 illustrates a flowchart of a method 200 for providing user data. The steps of the method 200 may be performed by any one or more of the components of the system 100 depicted in FIG. 1. For example, one or more steps of the method 200 may be implemented by a social network site (e.g., one or more social network servers). Alternatively, or in addition, one or more steps of the method 200 may be implemented by a general purpose computer having a hardware processor, a memory and input/output devices as illustrated below in FIG. 6. Although any one of the elements in system 100 may either singly, or in conjunction with any one or more of the other elements, be configured to perform various steps of the method 200, for illustrative purposes, except as otherwise indicated, the method will now be described in terms of an embodiment where steps of the method are performed at a social network site (or simply a “social network”) via one or more servers, such as social network site 101 in FIG. 1.

The method 200 begins in step 202 and proceeds to step 210.

At step 210, the method 200 registers an anonymous user profile of a user with a social network. For instance, a voluntary anonymous user profile is created on the social network site by a user via a user device. In one embodiment, the anonymous user profile is different from a general user profile on the social network, which may not be anonymous (at least within the bounds of the social network website/interface itself). In one embodiment, the anonymous user profile does not reveal any identifiable personal data about the user as dictated by the user. In some embodiments, it may contain a subset of actual user profile data as well as any other activity on the social network site that the user is willing to release. In one embodiment, at step 210 the method 200 filters out any user identifiable data, in order to protect the user's identity. In one embodiment, the user may utilize a screening tool developed for this purpose by the social network. In any case, the user is given control over how the data in the anonymous user profile is shared/provided with entities outside the social network (e.g., third parties, ad-servers, IPTV servers, etc.). In one embodiment, the anonymous user profile, once created, may be available for updating by the user at any time to reflect the user's current interests, to change settings so as to reveal more or less of the anonymous user profile, and to make other changes. In one embodiment, the user registers the anonymous user profile by creating a user ID and password. The same user ID and password may be used to access the anonymous user profile, and its settings, at later occasions.

At step 220, the method 200 provides an anonymous user identifier to a device of the user. For example, the method 200 may associate the anonymous user identifier with the anonymous user profile created at step 210. The association may be stored in a database (e.g., along with the anonymous user profile, or in a separate database). In one embodiment, the anonymous user identifier is provided to the user's device in the form of a profile-ID cookie, or simply a “cookie”. As defined by the World Wide Web Consortium: “A cookie is a small piece of information, often no more than a short session identifier, that the HTTP web server sends to the user's browser when the browser connects for the first time. Thereafter, the browser returns a copy of the cookie to the server each time it connects to the web site. The server may use the cookie to remember the user and to maintain the illusion of a “session” that spans multiple pages.” Typically, cookies are stored in a user computer by a web site during the user's first visit. Minimally, a cookie may contain a name-value pair such as, customer-564428. That number identifies the customer's profile stored on the web sites' server(s). During subsequent visits to the same web site, the user's browser transmits the cookie so that the web site can tailor ads and/or content based on the customer identity.

In the present disclosure, the profile-ID cookie is made available by a browser of a user device to visited web sites. The cookie could be promiscuous (e.g., any web site the user visits can read the cookie), or with limited site access per user discretion. Additionally, in some embodiments, a browser of the user device may include the new feature of a button on the browser window for the user to turn off/on the “visibility of the cookie” at will.

In one embodiment, the cookie only includes the anonymous user identifier, which may take the form of an assigned number, a set of alphanumeric digits (e.g., assigned codes comprising combination of number, letters and/or other digits). There is no user profile information, tracking data or other personal identifying information in the cookie. For instance, the cookie provided by the method 200 at step 210 will not contain identifiable user-id/password information, in contrast to a standard login cookie. Thus, a reference number/code in the cookie that is useable to identify the user is only significant to the social network. In other words, the cookie may be read by any other site, but it will be intelligible only to the social network site.

For example, a name-value pair may be a standard universally unique identifier (UUID) (something only intelligible to the social network to identify the user). Any rogue web site accessing the cookie from an end-user computer will not be able to abuse it. For additional security, the anonymous user identifier provided at step 210 can be changed/updated from time to time. This may further thwart attempts to link the anonymous user identifier to personally identifiable information or other tracking information with respect to the user's online activities. Further, in various embodiments, the user may be given control (e.g., via an on-off button on a browser interface of the user's device) to allow/disallow a web site to read access the cookie.

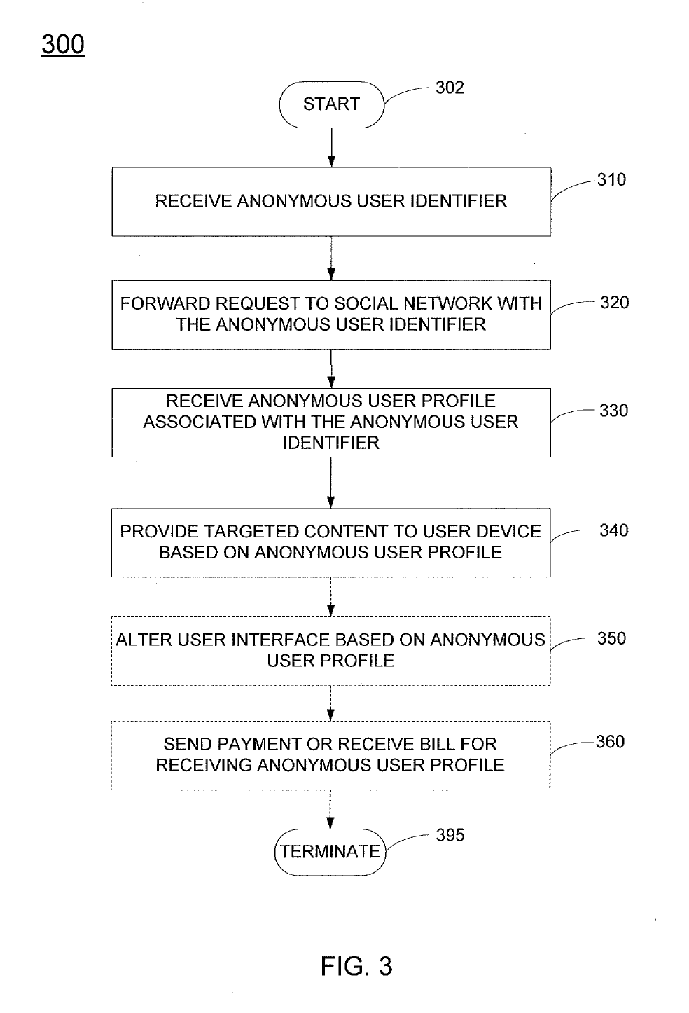

At step 230, the method 200 receives a request from a third party with the anonymous user identifier. For example, in various embodiments, the anonymous user identifier may be provided to various third party servers/advertising servers by the user device (e.g., via a web browser of the user device during a web browsing session, via an IPTV interface when viewing IPTV, etc.), as described in further detail below in connection with the method 300 of FIG. 3. In another embodiment, the method 200 may also receive a third party's URL (e.g., a web site's uniform resource locator) from the user device. However, the user may disable this feature for privacy reasons, so that the social network would not be able to track the user's web behavior or television viewing behavior. In one embodiment, the third party reads the cookie sent from the user device and forwards the anonymous user identifier contained therein to an advertising server. The advertising server, in turn, may forward the anonymous user identifier to a social network storing anonymous user profiles. However, in some embodiments, the third party may send the anonymous user identifier directly to the social network. Accordingly, as described herein a “third party” may comprise all of: third party websites/web servers, IPTV servers as well as ad-agents/advertising servers, and the like. In any event, at step 230, the method 200 receives the request (e.g., from one of the above described third parties) for the anonymous user profile associated with the anonymous user identifier.

At step 240, the method 200 determines if the requesting third party is authorized to receive the anonymous user profile data. For example, the method 200 may verify the third party's credentials. For instance, the method 200 may maintain a list of known legitimate ad-servers. In addition, various third-parties may have preexisting contractual relationships with the social network for accessing anonymous user profile data which may set forth terms under which the third party will compensate the social network for sharing anonymous user profile information (e.g., pay per access, a flat monthly fee, additional charges for anonymous user profiles that reveal larger amounts of user information versus those that reveal relatively less, and numerous other variations of this nature). In one embodiment, the method 200 carries out the process of step 240 via an authentication and billing system (e.g., a server) of the social network. In addition, the method 200 may compare the requesting third party's information to information that may be provided by the user device (e.g., a third party website's URL) to match the requestor's credentials to the actual URL the user is visiting. This may prevent fraudulent requests which purport to originate from a known/trusted third party, but in fact come from elsewhere. If the third party is not authorized/authenticated at step 240, the method 200 proceeds to step 295 where the method ends. Optionally, the method 200 may provide a response to the third party inviting the third party to participate in a contract for accessing anonymous user profile information according to a subscription or other arrangement. If, however, the third party is a known entity according to a pre-existing arrangement, or is otherwise deemed authorized at step 240, the method 200 proceeds to step 250.

At step 250, the method 200 releases the anonymous user profile information to the third party. For example, as described above, a voluntary anonymous user profile may not reveal any identifiable personal data about the user. However, it may contain a subset of an actual user profile as well as any other activity on a social networking site that a user is willing to release. Accordingly, in one embodiment, the third party would see only such things as the age group, male/female status, hobbies and/or recent activities of the user. However, the third party may still provide targeted content (e.g., advertising/content or even personalized interfaces) having been equipped with such information. While the third party does not have full details of a user's browsing history, viewing history or social network activities, the third party will have significant information about a user's profile/interests in order to provide relevant and targeted advertising or other content. Further details are discussed below in connection with the exemplary method 300.

In one embodiment, following step 250, the method 200 proceeds to optional step 260 where the method 200 bills the third party for receiving the anonymous user profile information. For example, as indicated above, the third party may have a pre-existing contractual relationship with a social network for sharing/accessing anonymous user profile information. If the third party has arranged for pay-per-access, the method 200 may send an invoice to the third party according to an agreed upon fee for each accessing of an anonymous user profile. Alternatively, or in addition, the method 200 may keep track of each instance where anonymous user profile data is provided to the same third party and send a monthly invoice. Various other billing and payment arrangements may be provided at step 260 in accordance with embodiments of the present disclosure. Following step 260, the method 200 may proceed to step 295 where the method ends. However, in some embodiments the method 200 may further proceeds to optional step 270.

In one embodiment at step 270, the method 200 provides credit to a user whose anonymous user profile was shared/accessed. For example, a user may be incentivized by the method 200 to share a greater amount of details in the anonymous user profile with third parties. For instance, a social network associated with the method 200 may derive greater revenue from third parties for sharing anonymous user profiles that reveal a relatively greater level of information (e.g., with respect to the interests, location, sex, income, etc., of the user). Accordingly, as incentive to the users to reveal more information, the method 200 may provide payments/credits to users based upon the sharing of the anonymous user profile. In one embodiment, users revealing more detailed information, as compared to than those who choose to reveal very little or no details at all, may receive greater rewards/compensation. In one embodiment, users with greater numbers of friends or followers associated with their respective user profiles may receive greater compensation than those users with less friends or followers. In various embodiments, the method 200 may provide the user with online credits (e.g., for use in purchasing items of value from the social network site, or even third party sites). In still other embodiments, the user may receive actual money/currency from the social network, or other forms of valuable compensation such as travel miles, discount coupons, and the like. At step 295, the method terminates.

FIG. 3 illustrates a more detailed flowchart of certain steps of a method for providing targeted content to a user. In particular, the steps of the method 300 may comprise, overlap or supplement any one or more of steps 210-270 of the method 200, and similarly may be performed by any one or more of the components of the system 100, depicted in FIG. 1. For example, one or more steps of the method 300 may be implemented in whole or in part by an advertising server, third party server (e.g., a web server), or an IPTV server. Similarly, it should also be understood that one or more steps of the method 300 may be implemented by a general purpose computer having a processor, a memory and input/output devices as illustrated below in FIG. 6.

The method 300 begins in step 302 and proceeds to step 310. At step 310 the method 300 receives an anonymous user identifier. For example, in one embodiment a user, via a browser or other interface of a user device, may visit a website that includes advertising or other content that the website desires to personalize/target to each visitor. Accordingly, the method 300 may receive an anonymous user identifier via a cookie provided from the user's device upon visiting such a website. In still another embodiment, a user may interact with an IPTV provider via a set-top box interfacing with an IPTV server. In some embodiments of the present disclosure, a new “profile selection” icon (e.g., a button) is provided on the console screen for IPTV. By clicking the icon, the end-user may select the correct profile to be used in targeted advertising via the IPTV system (e.g., if a family shares an IPTV service, there may be several anonymous user profiles to select). Accordingly, in such embodiments the method 300 may receive the anonymous user identifier via a cookie or similar mechanism via the IPTV set-top box.

In one embodiment, the user may choose to share this cookie, or not, depending upon the user's preferences. For example, the user may be given control (e.g., via an on-off radio button on a browser interface or ITPV interface, depending upon the particular embodiment) to allow/disallow a third party to read access the cookie. However, a user may desire to share the anonymous user identifier in order to gain revenue or credits with a social network according to an arrangement between the user and the social network. Sending cookies from a user's browser to a web-site's server is a known HTTP technology. The server side scripting such as CGI (common gateway interface), is able to interpret the cookie data passed by a user's browser. Any data sent by the user device (client) is readable by the web site's server. To interpret the data correctly the client and the server need to agree on name-value pairs. Still, in any case if the user only chooses to provide the cookie, the website does not receive any personally identifying information at this time.

At step 320, the method 300 forwards a request to a social network including the anonymous user identifier received at step 310. In particular, the request may seek anonymous user profile data associated with the anonymous user identifier. For example, as described in connection with step 210 of the method 200 above, a user may create an anonymous user profile with a social network that can be shared for targeted content/advertising, revenue generation and revenue sharing purposes, among other things. In addition, this anonymous user profile may be shared by the social network with third parties according to the explicit preferences of the user, as set in the privacy settings of the anonymous user profile. In order to access the anonymous user profile, however, a third party must present an anonymous user identifier to the social network and must also be authorized by the social network. Thus, at step 320 it is assumed that the method 300 is performed on behalf of an entity authorized to receive anonymous user profile data from a social network (e.g., an authorized third party web server, IPTV server, advertising server or the like). Accordingly, in one embodiment the method 300 forwards the request to the social network directly from a third party server (e.g., a web server or IPTV server). However, in another embodiment, the method 300 forwards the request from an advertising server. For example, a third party server may receive the anonymous user identifier via a cookie. However, the third party server may rely upon an external advertising provider to provide advertising (and usually to generate revenue) for the service associated with the server. As such, the advertising server may be responsible for selecting which advertisements to place on various portions of the webpage(s) of the website for each visitor, in the case of a web browsing embodiment, or may select which advertisements to display during which time slots and in which locations on a screen for an IPTV viewing embodiment. Thus, in some embodiments, the anonymous user identifier may be sent from a third party server to an advertising server, from which the method 300 then forwards the request to the social network.

At step 330, the method 300 receives an anonymous user profile associated with the anonymous user identifier. As described above, the anonymous user profile may contain data with respect to the interests, location, sex, income, etc., of an associated user. Notably, the user associated with the anonymous user profile data is the same user sending the anonymous user identifier that is received by the method 300 at step 310. In one embodiment, the method 300 receives the anonymous user profile data at an advertising server. However, in another embodiment, the method 300 may receive the anonymous user profile data at a third party web server directly from the social network.

At step 340, the method 300 provides targeted content to a device of the user based on the received anonymous user profile data. For example, the method 300 may provide targeted advertising relating to the interests or demographic information of the user listed in the anonymous user profile data received at step 330. For instance, in one embodiment, the user may indicate in the anonymous user profile that he or she is receptive to receiving targeted advertising/content pertaining to “the Caribbean”. Accordingly, the method 300 may determine that targeted content relating to this subject should be provided to the user's device. For instance, advertisements from one or more cruise lines for Caribbean cruises may be displayed on advertising portions of a webpage visited by the user. If at some point the user removes “the Caribbean” from current interests in the anonymous user profile, third parties will no longer see this information when subsequently requesting the anonymous user profile from the social network. Thus, a third party participating in the method 300 is no longer likely to deliver Caribbean cruise advertisements to this particular user.

As mentioned above, in some embodiments, the method 300 may receive the anonymous user profile data at an advertising server. Accordingly, in such embodiments, at step 340, the method 300 may provide the targeted content/targeted advertising from an advertising server to a third-party web server, for display on a webpage of the third party's website, or to an IPTV server, for display in designated screen locations at designated times. In some embodiments, it should be noted that the method 300 may display generic or default content and/or advertisement(s) to a user device prior to receiving the anonymous user profile and prior to delivering targeted content/advertising according to steps 310-340. Such embodiments allow a user device to load a webpage or IPTV channel without any delay associated with the method performing steps 310-330, while still permitting all the advantages described herein with respect to delivering and receiving targeted content.

In one embodiment, following step 340, the method 300 proceeds to step 395 where the method terminates. However, in some embodiments, the method 300 then proceeds to optional step 350 and/or step 360.

At step 350, the method 300 alters a user interface based on the user profile. For example, if an anonymous user profile indicates a current interest in the Caribbean, the method 300 may determine to display current weather information for the Caribbean region on a portion of the current display on the user device. However, if no such preference or interest is indicated in the anonymous user profile, the method 300 may simply display weather information based on a location estimated from the visiting user device's internet protocol address, based on a location of a third party server associated with the method 300, or based on other criteria.

In one embodiment, at step 350, the method 300 takes advantage of “semantic web”0 or Web 3.0 technology, which is an emerging technology characterized as a machine readable “web of data” with a goal to enable the automatic integration of information from across the web. The end result is the addition of computer-processable meaning (semantics) to the World Wide Web. The currently prevalent URLs (uniform resource locators) are replaced by constantly modifiable URIs (uniform resource identifier). Various embodiments take advantage of the semantic web technology to tailor web page content to the end-user based on the social network voluntary anonymous user profile data. The internet of today contains myriads of web pages each with its own URL. Endpoints/user devices can search for a specific document, but it still has to be read and interpreted by a human before any useful information can be extracted. In the semantic web, instead of a single URL per page, each piece of information contained in the web page has its own URI with all such URIs cataloged and linked together. The transformation is such that, instead of a multitude of disjointed documents, a vast conglomerate of relational databases is created.

To achieve this goal, metadata (data that describes other data) is defined for each information snippet on the internet. In some embodiments, resource description framework (RDF) is used for associating metadata with web data. One goal is to create a comprehensive web ontology for the Internet. Each data resource and how it relates to other data is specified via a taxonomy (system of classification) and inference rules. This enables machines to make logical conclusions rather than just searching web pages for keyword strings.

Thus, in some embodiments, at step 350 the method 300 may, within the context of the “semantic web”, provide different content or different interfaces to a user, depending upon the anonymous user profile data received at step 350. In particular, the method 300 may call different URIs to populate data on a web page displayed to a user depending upon the anonymous user profile data. In some embodiments, following step 350 the method 300 then proceeds to step 360. However, in other embodiments the method 300 simply proceeds to step 395 where the method terminates.

At step 360, the method 300 sends payment for receiving the anonymous user profile. For instance, as described above in connection with step 260 of the method 200, a social network may bill third parties for providing the anonymous user profile information. For example, as indicated above, a third party may have a pre-existing contractual relationship with a social network for sharing/accessing anonymous user profile information. If the third party has arranged for pay-per-access, the method 300 may receive an invoice from the social network according to an agreed upon fee for each accessing of an anonymous user profile. Alternatively, or in addition, the method 300 may keep track of each instance where anonymous user profile data is accessed and send a monthly payment to the social network including all charges for accessing anonymous user profile information (e.g., according to a pre-determined schedule, as agreed between the social network and the third party). Various other billing and payment arrangements may be provided at step 360 in accordance with embodiments of the present disclosure (e.g., a flat monthly fee for unlimited access or a certain number of accesses of anonymous user profiles). At step 395, the method 300 terminates.

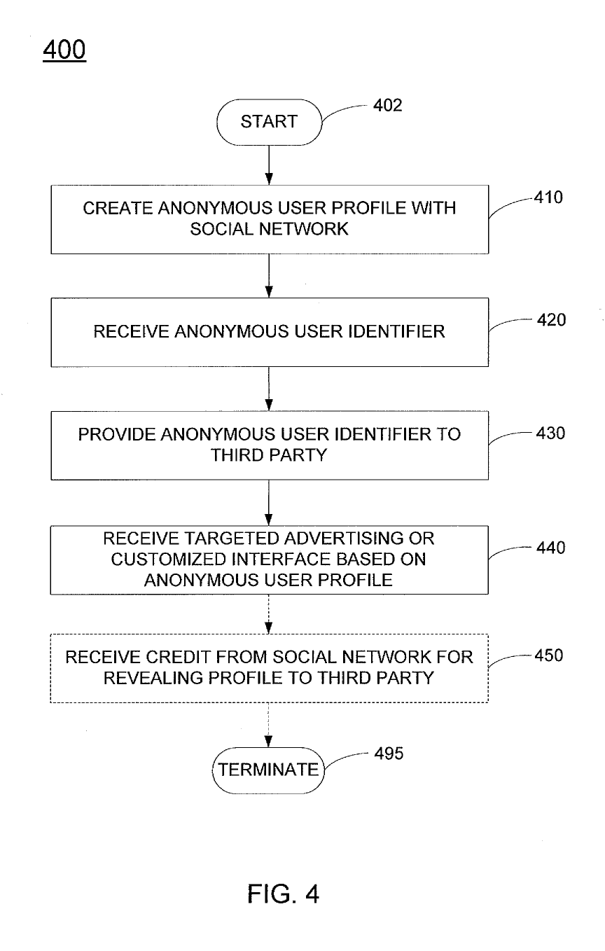

FIG. 4 illustrates a flowchart of a method 400 for receiving targeted content. In various embodiments, the steps of the method 400 may be performed by any one or more of the components of the system 100 depicted in FIG. 1, including any one or more of the user devices 121. Similarly, it should also be understood that one or more steps of the method 400 may be implemented by a general purpose computer having a processor, a memory and input/output devices as illustrated below in FIG. 6.

The method 400 begins in step 402 and proceeds to step 410.

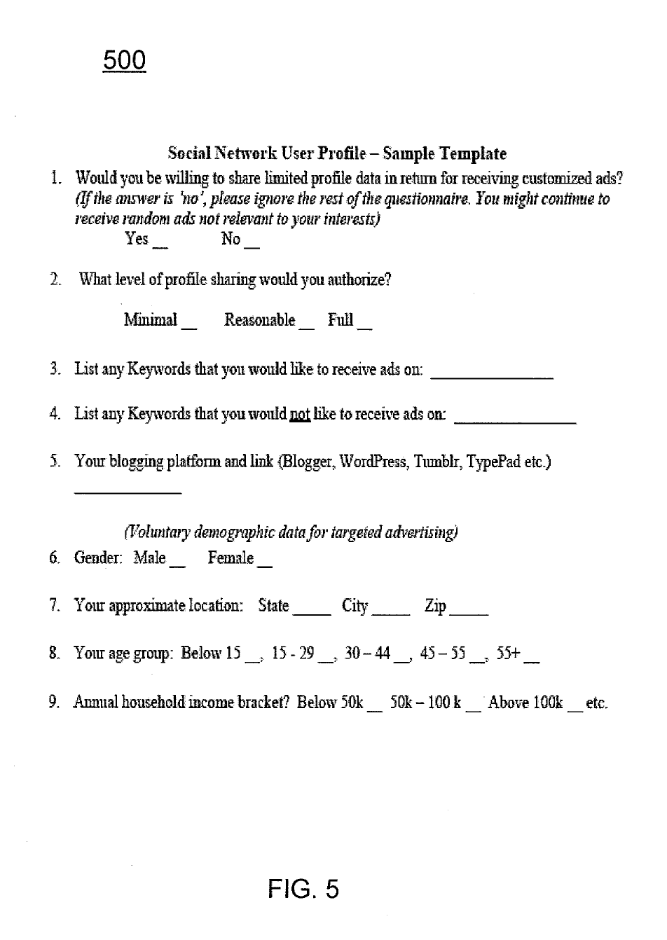

At step 410, the method 400 creates an anonymous user profile with a social network. For example, in accordance with the description above in connection with step 210 of the method 200, the method 400 may create/register an anonymous user profile with the social network. An exemplary user profile template 500 containing various information fields and privacy settings is shown in FIG. 5. As can be seen in the illustrative embodiment of FIG. 5, the user may choose several levels of privacy settings, for example: minimal, reasonable and full. In one embodiment, a minimal sharing level may authorize the sharing of only gender, age bracket, and location information, but no photos or user identifiable data. Similarly, a reasonable sharing level may authorize the sharing of pre-approved data suitable for targeted advertising but nothing personally identifiable (e.g., user preferences, user recommendations for songs/books/movies/food/gadgets, selected web postings, user's avatar links, and the like). Further, a full sharing level may reveal a user's entire social network profile to third parties. In addition to the privacy settings, the exemplary user profile template 500 also includes fields for various user data that may be revealed. For example, demographic data may be entered in fields 6-9. Similarly, the user may provide topics of interest in field 3. However, in some embodiments the user may also specify topics for which the user explicitly does not want to receive related content (e.g., a blacklist, field 4).

At step 420, the method 400 receives an anonymous user identifier. For example, in accordance with the description above in connection with step 220 of the method 200, the method 400 may receive an anonymous user identifier. In one embodiment, the anonymous user identifier is received in the form of a cookie from a social network.

At step 430, the method 400 provides the anonymous user identifier to a third party. For example, the method 400 may send the cookie received at step 420 (and containing the anonymous user identifier) to a third party server (e.g., a web server, an advertising server, or IPTV server). As described in connection with step 320 of the method 300, in some embodiments one third party server (e.g., a web server or IPTV server) may forward the anonymous user identifier to another third party server (e.g., an ad-agent/advertising server). In addition, in various embodiments, one of these third party servers may send the anonymous user identifier in a request to receive an associated anonymous user profile from a social network.

At step 440, the method 400 receives targeted advertising, customized content and/or an altered interface (broadly “targeted content”) based on the anonymous user profile, and the settings and data contained therein, at step 410. For example, a third party server may receive the anonymous user profile. The third party server may determine the targeted content to be presented based on the anonymous user profile. Accordingly, at step 440 the method 400 receives such targeted content determined by the third party server. The method 400 may then display the targeted content on a display of a user device (e.g., an IPTV, personal computer, a smart phone, a tablet, PDA and the like). In some embodiments, following step 440, the method 400 proceeds to step 495 where the method terminates. However, in some embodiments, following step 440 the method 400 proceeds to optional step 450.

At step 450, the method 400 receives credit from a social network. In particular, an account associated with the anonymous user profile may be credited with money/currency, virtual currency, online credits, points, miles, free content or services from the social network, one of the third parties or content providers, or other valuable consideration in exchange for the social network having shared the anonymous user profile with a third party. For instance, as described above in connection with step 270 of the method 200, as an incentive to a user to reveal more information, a social network may provide payments/credits based on each time an anonymous user profile is shared, and may provide more or less compensation depending upon the level of detail of user information revealed according the anonymous user profile settings. As an alternative, or in addition, in some embodiments, users with greater numbers of friends or followers associated with their respective user profiles may receive greater compensation than those users with less friends or followers.

Following step 450, the method 400 proceeds to step 495 where the method terminates.

It should be noted that although not specifically specified, one or more steps of each of the respective methods 200, 300 and 400 may include a storing, displaying and/or outputting step as required for a particular application. In other words, any data, records, fields, and/or intermediate results discussed in each of the respective methods can be stored, displayed and/or outputted to another device as required for a particular application. Furthermore, steps or blocks in each of FIGS. 2-4 that recite a determining operation or involve a decision do not necessarily require that both branches of the determining operation be practiced. In other words, one of the branches of the determining operation can be deemed as an optional step.

FIG. 6 depicts a high-level block diagram of a general-purpose computer suitable for use in performing the functions described herein. As depicted in FIG. 6, the system 600 comprises a hardware processor element 602 (e.g., a CPU), a memory 604, e.g., random access memory (RAM) and/or read only memory (ROM), a module 605 for performing various functions as described herein, and various input/output devices 606 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)). In some embodiments, module 605 may comprise computer/processor executable code containing a plurality of instructions for performing steps of the exemplary methods 200, 300 and/or 400.

Accordingly, it should be noted that the present disclosure can be implemented in software and/or in a combination of software and hardware, e.g., using application specific integrated circuits (ASIC), a general purpose computer or any other hardware equivalents, e.g., computer readable instructions pertaining to the method(s) discussed above can be used to configure a hardware processor to perform the steps of the above disclosed methods. For example, in one embodiment, the module or process 605 can be loaded into memory 604 and executed by processor 602 to implement the functions as discussed above in connection with any one or more of the exemplary methods 200, 300 and 400. As such, the present module or process 605 (including associated data structures) of the present disclosure can be stored on a non-transitory computer readable medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for sharing user data, comprising:
registering a user profile with a social network;
providing a user identifier associated with the user profile to a user device;
receiving a request from a third party with the user identifier;
determining via a processor whether the third party is authorized to receive the user profile; and
providing by the processor the user profile to the third party if the third party is authorized.

2. The method of claim 1, wherein the identifier is provided to the user device via a cookie.

3. The method of claim 1, further comprising:
receiving a payment from the third party for providing the user profile.

4. The method of claim 1, wherein the user profile is an anonymous user profile comprising a privacy setting that has been selected by a user.

5. The method of claim 4, wherein the privacy setting determines whether user data in the anonymous user profile is accessible to the third party.

6. The method of claim 4, wherein the providing the user profile comprises:
providing the anonymous user profile to the third party in accordance with the privacy setting.

7. The method of claim 1, wherein the third party comprises a web server.

8. The method of claim 1, wherein the third party comprises an advertising server.

9. The method of claim 1, wherein the third party comprises an internet protocol television server.

10. The method of claim 1, wherein the registering comprises:
registering the user profile with a website of the social network.

11. A method for providing targeted content, comprising:
receiving a user identifier from a user device;
forwarding a request to a social network with the user identifier;
receiving a user profile associated with the user identifier; and
providing the targeted content to the user device based on the user profile.

12. The method of claim 11, wherein the identifier is received from the user device via a cookie.

13. The method of claim 11, wherein the targeted content comprises an advertisement.

14. The method of claim 11, wherein the targeted content comprises an altered interface based on the user profile.

15. The method of claim 11, further comprising:
sending a payment to the social network for receiving the user profile.

16. The method of claim 11, wherein the user profile is an anonymous user profile comprising a privacy setting that has been selected by a user.

17. The method of claim 16, wherein the privacy setting determines whether user data in the anonymous user profile is accessible to a third party.

18. The method of claim 11, wherein the receiving the user profile comprises:
receiving the user profile by a third party from the social network when the third party is authorized by the social network.

19. The method of claim 11, wherein the request comprises a request to receive the user profile by a third party from the social network.

20. The method of claim 11, wherein the providing the targeted content is performed by an Internet protocol television server.
